(19) United States
(12) Patent Application Publication
(10) Pub. No.: US 2004/0221319 A1
(43) Pub. Date: Nov. 4, 2004

(54) Application streamer

(76) Inventor: Ian Zenoni, Highlands Ranch, CO (US)

Correspondence Address: Morrison & Foerster LLP, Suite 300, 1650 Tysons Boulevard, McLean, VA, 22102, US

(21) Appl. No.: 10/728,572

(22) Filed: Dec. 5, 2003

Related U.S. Application Data
(60) Provisional application No. 60/431,573, filed on Dec. 6, 2002.

(51) Int. Cl. H04N 7/173; G06F 13/00; H04N 5/445; H04N 7/16

(52) U.S. Cl. 725/132; 725/50; 725/139; 725/151; 725/95; 725/135; 725/140

(57) ABSTRACT

Disclosed is a method and system for managing the transmission of interactive information over a satellite broadcast system in a fashion that is compatible with a user's set-top box such that the user can view the interactive content. The interactive information comprises graphic and textual data that enhances the current video broadcast. The present invention converts textual data into OpenTV data and graphical data into MPEG data. OpenTV software located on the user's set-top box reads the interactive information and displays the interactive information on the user's display device. The interactive information comprises additional interactive movie information, sports information, weather, and other information. Transmitting additional information to the user in an interactive format enhances and improves the quality of the content being provided by the content provider, which allows the content provider to increase subscription fees and enjoy increased revenue.

### CROSS REFERENCE TO RELATED APPLICATIONS

The present application is based upon and claims the benefit of U.S. Provisional Patent Application Serial No. 60/431,573 by Ian Zenoni, entitled “Application Streamer” filed Dec. 6, 2002, the entire contents of which is hereby specifically incorporated by reference for all it discloses and teaches

### BACKGROUND OF THE INVENTION

1. Field of the Invention

The present invention pertains generally to satellite television broadcasts and more particularly to transmitting interactive satellite broadcast streams to a user.

2. Description of the Background

Currently, content providers such as Showtime and The Movie Channel (content providers) transmit non-interactive broadcast information to a user through a satellite network to the user's set-top box (STB). Herein, “user” is defined as a person watching the broadcast. The information transmitted by the content providers may comprise movies, special programming, special-order broadcasts, and so on. At this time there is no method for transmitting interactive content, in XML and JPEG/BMP format, from a content provider, over a network connection, through a satellite system to a user's set-top box. That is, there is no method for providing the user with the option of obtaining such additional information in an interactive format through a satellite broadcast system.

A need therefore exists for transmitting interactive information over a satellite broadcast system by converting textual data, such as XML data, and graphics data, such as JPEG and BMP data, into data that can be viewed on the user's television set in an interactive fashion. It would also be beneficial to convert XML, JPEG and BMP data, provided by a content provider, into data that can be transmitted over a satellite broadcast system in a fashion that is compatible with a user's set-top box.

### SUMMARY OF THE INVENTION

The present invention overcomes the disadvantages and limitations of the prior art by providing a method and system in which interactive video content can be transmitted from a content provider to a user over a satellite system in a fashion that is compatible with a set-top box such that the user can view the interactive content. This can be accomplished by converting data in XML format into OpenTV data. Open TV data is interactive data that is readable by OpenTV software. OpenTV software may be located on the user's set-top box and may display the OpenTV data to the user on the user's display device. This can also be accomplished by converting data in JPEG and BMP format into MPEG data.

The present invention may therefore comprise a method for sending interactive textual and graphical data from a content provider to a user's set-top box through a satellite broadcast system comprising: sending the textual data and the graphical data from the content provider to a server that is located in an uplink center; converting the textual data into OpenTV data and converting the graphical data into MPEG data by using an application streamer that is coupled to the server and that retrieves the textual data and the graphical data from the server; using the application streamer to create a file directory structure based on the textual data; using the application streamer to create a node tree on a broadcast streamer by mirroring the file directory structure; mapping nodes in the node tree to files in the file directory structure; allocating bandwidth and transmission frequency of the node based on priority of the node; using the broadcast streamer to multiplex the OpenTV data and the MPEG data with a regular broadcast stream resulting in an interactive data stream; sending the interactive data stream to the user's set-top box; using set-top box application software to read the interactive data stream and display the interactive data stream on a user's display device; and, monitoring the application streamer with a computer.

The present invention may further comprise a system for sending interactive textual and graphical data from a content provider to a user's set-top box through a satellite broadcast system comprising: a server, located in an uplink center, that receives the textual data and the graphical data from the content provider; an application streamer, that is coupled to the server, that retrieves the textual data and the graphical data from the server and that converts the textual data into OpenTV data and converts the graphical data into MPEG data; a file directory structure that is created by the application streamer based on the textual data; a node tree that is created by the application streamer on a broadcast streamer by mirroring the file directory structure; nodes in the node tree that are mapped to files in the file directory structure; bandwidth allocation software, in the application streamer, that calculates transmission frequency of the node based on priority of the node; a multiplexer located on the broadcast streamer that multiplexes the OpenTV data and the MPEG data with a regular broadcast stream resulting in an interactive data stream; a set-top box that receives the interactive data stream, a software application located on the set-top box that reads the interactive data stream and displays the interactive data stream on a user's display device; a computer that monitors the application streamer.

An advantage of the present invention is that additional interactive information may be provided to users that have satellite television systems. As such, the user may take advantage of all of the features of interactive television using a satellite system. For example, a user may view interactive actor biographies, movie posters, and other items of interest that relate to the user's favorite movies. The user may also select movies based on such interactive content. Other content, such as sporting events, athlete information, news, weather, stocks, and so on, may also be viewed in conjunction with an interactive system. The user may also view home shopping networks, historical information, do-it-yourself information, soap opera actor biographies and story lines, and more. Another advantage of the present invention is that transmitting additional information to the user in an interactive format enhances and improves the quality of the content being provided by the content provider, which allows the content provider to increase subscription fees and enjoy increased revenue.

### BRIEF DESCRIPTION OF THE DRAWINGS

FIG. 1 is a block diagram of an embodiment of the present invention.

FIG. 2 is a flow diagram illustrating the steps carried out by the embodiment of FIG. 1.

FIG. 3 is a flow diagram illustrating the steps performed by an application streamer in preparing data received from a content provider for viewing by a user.

FIG. 4 is an illustration of a file directory structure created by the application streamer.

FIG. 5 is an illustration of a graphical user interface (GUI) that is used that is used to create nodes.

FIG. 6 is a graphical representation of a text node.

FIG. 7 is a graphical representation of a graphics node.

FIG. 8 is a flow diagram illustrating the steps performed by a broadcast streamer in carrying out the embodiment of FIG. 1.

### DETAILED DESCRIPTION OF THE INVENTION

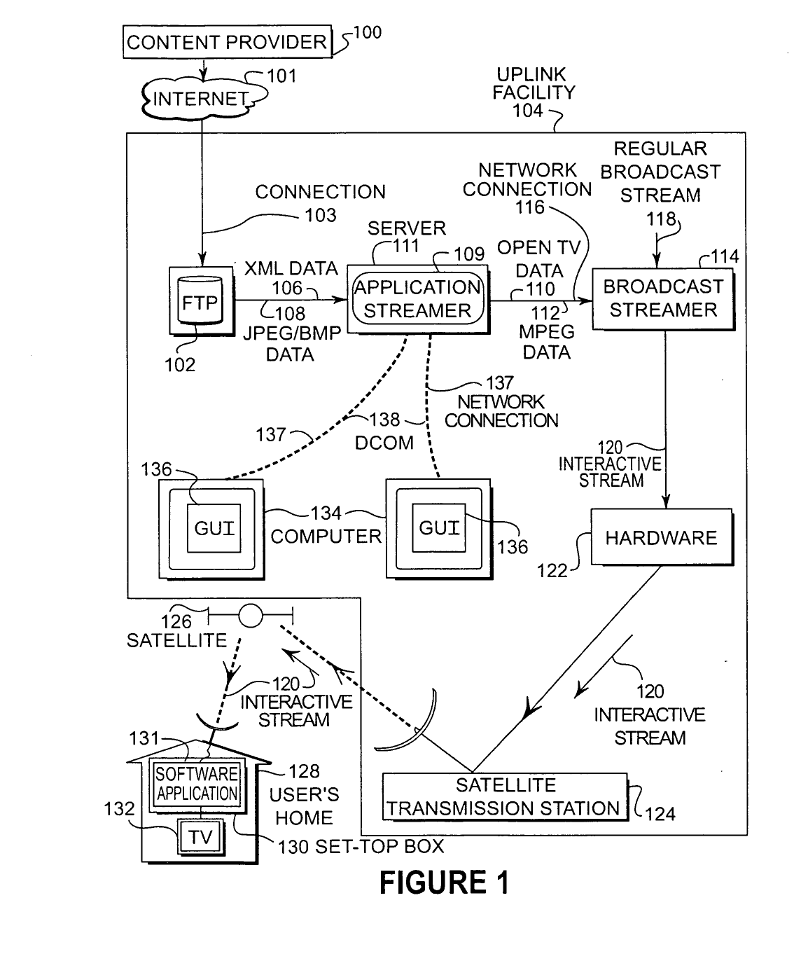

FIG. 1 is a block diagram of an embodiment of the present invention. Referring to FIG. 1, a content provider 100 may transmit information to a file transfer protocol (FTP) server 102 located in an uplink facility 104. In a satellite broadcast system, an uplink facility is the equivalent of a head-end in a ground television broadcast system. The content provider 100 may comprise a television network, television studio, a live broadcast, an Applications Service Provider, an Internet Service Provider, or other content provider. Television networks may comprise Echostar, ESPN, FOX, MSNBC, the Weather Channel, or other networks providing movies, sports, news, weather, and other information. The content provider may provide a user with interactive content. The content provider may provide the user with the option of viewing additional information about movies. Such additional information may comprise actor biographies, information about making the movie, movie posters, movie box covers, and other information. Textual data such as autobiographies may be presented to the user in OpenTV format. Graphical data may be presented to the user in Motion Picture Experts Group (MPEG) “stills” format. A MPEG “still” may comprise a still-picture of a movie clip that is one frame in length.

Referring again to FIG. 1, the content provider 100 may send textual and graphical data to an FTP server 102 located in the uplink facility 104. The textual data may comprise extensible markup language (XML) format 106. Of course, the embodiment of FIG. 1 is not limited to receiving/processing only XML textual data. The embodiment of FIG. 1 may receive/process textual data in any format, including binary, ASCII, or other format. The textual data may also be supplied by a database. Graphical information may comprise Joint Photographic Experts Group (JPEG) data, bitmap image (BMP) data, or any other format capable of representing graphical information. The content provider may send the text and graphics data over the Internet 101 to the FTP server 102. Of course, other means may be used to transmit data from the content provider 100 to the uplink facility 104, including client server methods, CD-ROM, tapes, and any other means capable of transmitting data to the uplink facility 104. The connection 103 between the content provider 100 and the FTP server 102 may comprise an ethernet connection, a network connection, or any high-speed connection. An application streamer 109 may retrieve the textual data and graphics data from FTP server 102. Textual data sent to FTP server 102 from content provider 100 may comprise any format, including XML format. Graphical data sent to FTP server 102 from content provider 100 may comprise any format, including JPEG and BMP format. Referring to FIG. 1, application streamer 109 may retrieve XML data 106 and JPEG/BMP data 108 data from FTP server 102. Application streamer 109 may comprise software that runs as a Windows NT/2000/XP service on a personal computer (PC) or server 111. Server 111 may comprise a storage device such as a computer hard drive, or any other type of storage device. The application streamer 109 may be coupled to the FTP server through a network connection.

Turning again to FIG. 1, the application streamer 109 may retrieve the XML data 106 and JPEG/BMP data 108 and convert the XML data 106 into OpenTV data 110. The application streamer 109 may convert the JPEG/BMP data 108 into MPEG-stills 112. As stated previously, other formats of textual and graphical data may be converted to OpenTV data 110 and MPEG-stills 112 by application streamer 109.

Looking again to FIG. 1, the application streamer 109 may transmit the OpenTV data 110 and MPEG-stills 112 to a broadcast streamer 114. Broadcast streamer 114 may comprise a server. Broadcast streamer 114 may comprise a storage device such as a computer hard drive or any other type of storage device. The broadcast streamer 114 may be coupled to the application streamer 109 by a network connection 116. The broadcast streamer 114 may receive the OpenTV data 110 and MPEG data 112 from the application streamer 109, as well as a regular broadcast signal 118 from within the uplink facility 104. The broadcast streamer 114 may comprise a multiplexer that multiplexes the OpenTV data 110 and MPEG data 112 with a regular broadcast stream 118. Of course, the uplink facility 104 may submit multiple broadcast streams 118 to broadcast streamer 114. Multiplexing the OpenTV data 110 and MPEG data 112 with regular broadcast stream 118 may create a single broadcast that contains interactive data (an interactive stream 120). The multiplexer may comprise standard, off-the-shelf technology. An example of a pre-existing multiplexer is the OpenTV Broadcast Streamer v2.1.

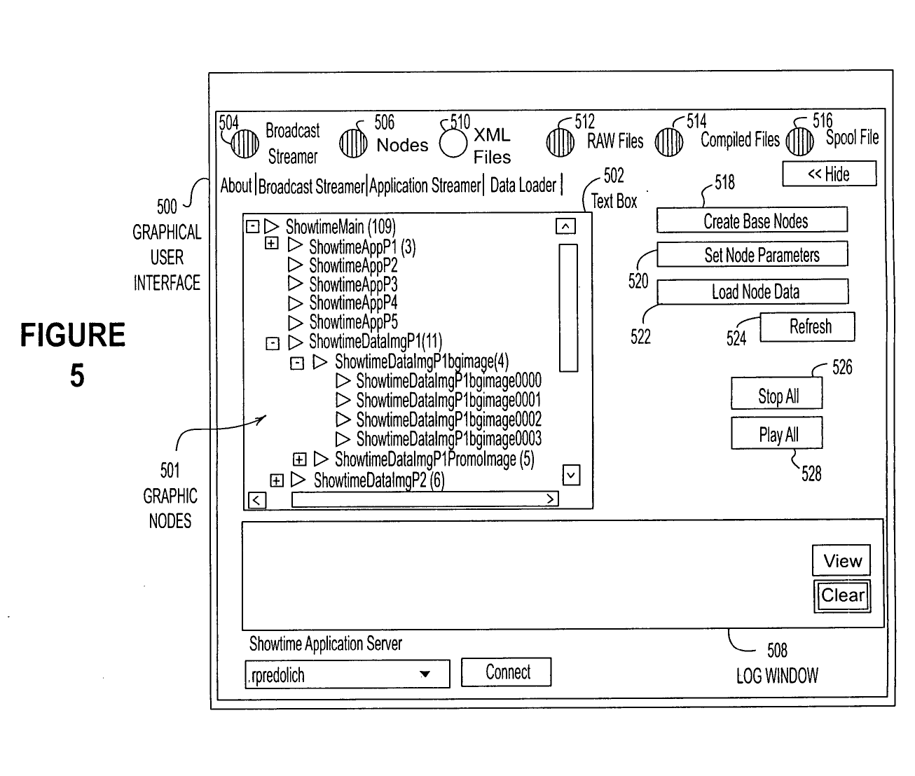

Referring again to FIG. 1, the broadcast streamer 114 may then transmit the interactive stream 120 to a set of hardware 122. Hardware 122 may comprise standard satellite system technology. The hardware 122 may receive the interactive stream 120 and transmit the interactive stream 120 to a satellite transmission station 124, which in turn may transmit the interactive stream 120 to a satellite 126 orbiting the earth. The satellite 126 may then beam the interactive stream 120 to the user's home 128. The embodiment of FIG. 1 may further comprise an OpenTV application, located on a set-top box 130, that may read the interactive stream 120 and display interactive stream 120 to a user on the user's display device 132. The embodiment illustrated in FIG. 1 may also include a computer 134 located in the uplink facility 104 that is used to monitor the function of the application streamer 109. Of course, computer 134 may comprise multiple computers in uplink facility 104. The computers 134 may monitor, configure, and make any necessary changes to the application streamer 109. The computers 134 may have a graphical user interface (GUI) 136 installed that implements methods of monitoring the application streamer 109. GUI 136 is described in more detail below with regard to the description of FIG. 5. The computers 134 may be coupled to the application streamer 109 via a network connection 137 such as an ethernet connection. The computers 134 may utilize a distributed component object model (DCOM) user interface 138. DCOM 138 is a windows programming standard that allows the computers 134 to be run from any location within the uplink facility 104 and to connect to any number of application streamers 109. The application streamer 109 may also monitor the connection to the broadcast streamer 114, the connection to the FTP server 102, the status of the interactive stream 120, and may query the FTP server 102 for new data received from content provider 100.

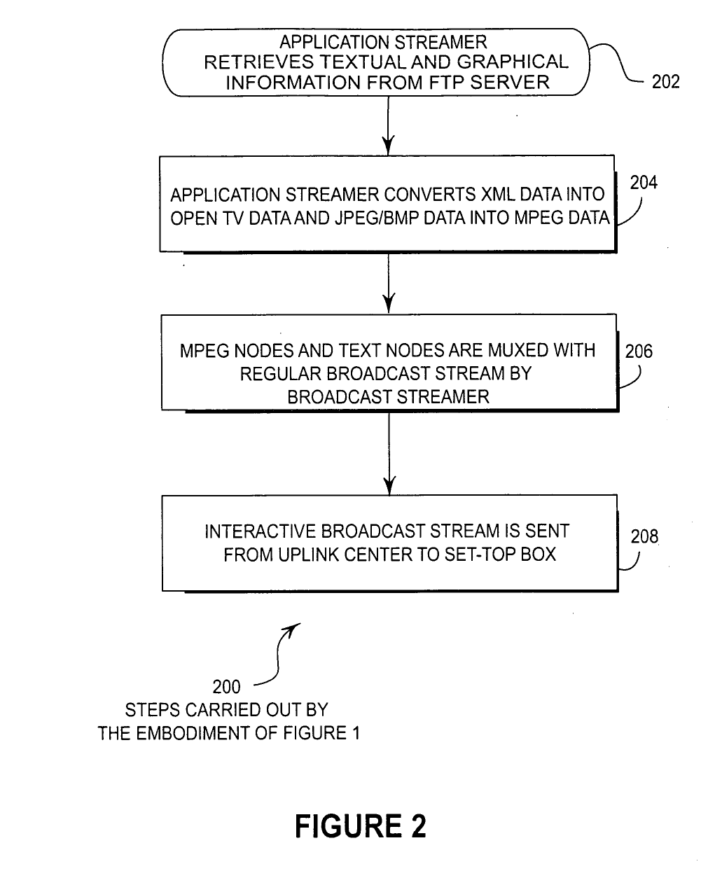

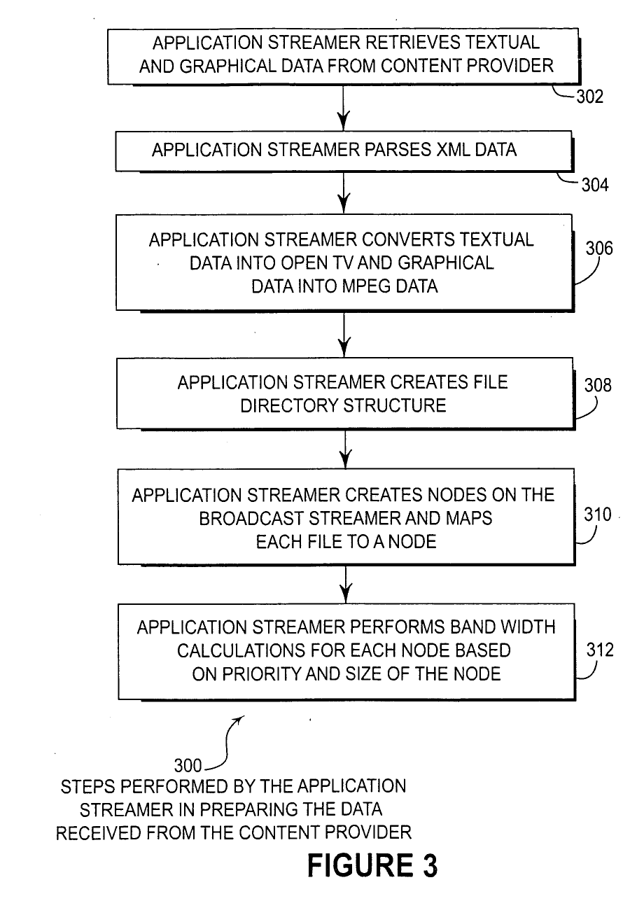

FIG. 2 is a flow diagram illustrating the steps 200 carried out by the embodiment of FIG. 1. Referring to FIG. 2, textual and graphical information may be retrieved by the application streamer 109 in step 202. The textual information may comprise XML data and the graphical information may comprise JPEG/BMP data. The process proceeds to step 204, where the application streamer 109 converts XML data into OpenTV formatted files and converts JPEG/BMP data into MPEG formatted files. Conversion of XML data into OpenTV data and JPEG/BMP data into MPEG data is discussed in more detail with regard to the description of FIG. 3. The application streamer 109 then creates nodes, which map to each file, on the broadcast streamer 114. “Nodes” may comprise interactive blocks of data that are streamed out of the uplink facility 104 along with a regular satellite broadcast stream 118. Turning again to FIG. 2, the process then proceeds to step 206 where MPEG nodes and text nodes (OpenTV nodes) are multiplexed into the regular broadcast stream 118 by the broadcast streamer 114. The process then proceeds to step 208 where the resulting interactive stream 120 is sent from the uplink center 104 to software 131 (OpenTV application) on a user's set-top box 130 in the user's home 128. When the user selects additional information, the set-top box software 131 may extract the additional information from the interactive broadcast stream 120.

FIG. 3 is a flow diagram illustrating the steps 300 performed by an application streamer in preparing data received from a content provider for viewing on the display device 132. Referring to FIG. 3, the application streamer 109 may retrieve textual and graphical data from a content provider 100 in step 302. The data provided by the content provider 100 may comprise textual and graphical information. As previously discussed with regard to the description of FIG. 2, the textual data may comprise additional textual information, such as biographical information about a movie actor, information about the creation of a movie, or other information. The textual data may comprise any format, including XML format. Conversely, graphical information supplied by content provider 100 may comprise any graphical information, including movie posters, box covers, actor pictures, etc. The graphical information may comprise any format, including JPEG and BMP format. The content provider 100 may send the textual and graphical data to a FTP server 102 over the Internet 101. The connection 103 between content provider 100 and the FTP server 102 may comprise an ethernet connection, a network connection, or any other high-speed connection. The application streamer 109 may process the textual and graphical data in such a way that the textual and graphical data may be presented to a user in an interactive fashion. Presenting the textual and graphical data in an interactive fashion may comprise converting the textual and graphical data into OpenTV (interactive) data. Software application 131 located on set-top box 130 may process the OpenTV data. The software application 131 may comprise OpenTV software. The OpenTV data may then be presented by display device 132.

Turning again to FIG. 3, the process proceeds to step 304 where textual data, which may be in the form of XML code, is parsed by the application streamer 109. The XML data may comprise textual information and references to pictures. The XML data may also comprise data that provides instruction to the application streamer 109 as to which files are to be converted to MPEGS. The process then continues to step 306, where application streamer 109 may convert the XML data into an OpenTV formatted file. Conversion of XML data to OpenTV data may be achieved using existing technology. Conversion of XML data to OpenTV data may comprise parsing the XML code to create textual code modules (textual code files). At the same time, the graphical data may be converted into an MPEG formatted file. The MPEG formatted file may comprise an MPEG “still” (a still-picture such as a movie shot, movie poster, actor picture, etc). Conversion of JPEG and BMP files into MPEG files may be achieved by using standard “off-the-shelf” technology, such as an OpenTV product called “OTVFrame”. Conversely, other standard graphical programs may be used to convert JPEG and BMP files into MPEG files, such as Photoshop.

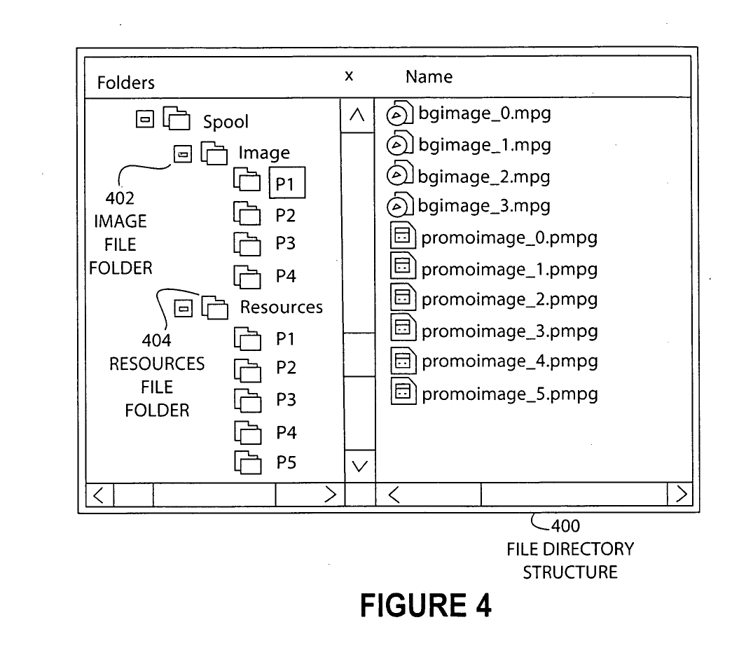

Looking again to FIG. 3, the process proceeds to step 308, where the application streamer 109 may place the OpenTV formatted files and MPEG formatted files into a file directory structure. The file directory structure may comprise separate file folders for text and graphics. A more detailed discussion of the file directory structure is described below with regard to the description of FIG. 4. The order of the file directory structure may be determined from data within the XML code that was parsed by application streamer 109. The XML code may comprise size of file, popularity of a movie, movie cast, year movie was released, or other information that may be used as criteria for separating the files into a hierarchical structure based on priority. “Priority” of the formatted files may determine the amount of bandwidth that will be assigned to each file. A more detailed description of priority and bandwidth calculations can be found below with regard to the description of FIG. 3.

Referring again to FIG. 3, the process proceeds to step 310, where the application streamer 109 may read the converted XML files (the OpenTV formatted files) and converted graphics files (the MPEG formatted files) that have been placed in the file directory structure. The application streamer 109 may then create nodes. As previously discussed with regard to the description of FIG. 2, “nodes” are defined as interactive blocks of data that are streamed out of uplink facility 104 along with a regular satellite broadcast stream 118. Text nodes may be created by converting the textual code modules/files into OpenTV resource modules/files which are in turn converted into text nodes. MPEG nodes may be created by converting the MPEG formatted files into MPEG nodes. OpenTV resource modules are used by the OpenTV application 131 to read textual data. Graphics nodes are also read by the OpenTV application 131. The nodes for both the OpenTV-formatted files and the MPEG-formatted files may be created by the application streamer 109 by mirroring the file directory structure of OpenTV-formatted files and MPEG-formatted files. The application streamer 109 may then create a node tree from the text nodes and graphics nodes on broadcast streamer 114. The order of the node tree on broadcast streamer 114 therefore mirrors the order of the file directory structure on application streamer 109. Each OpenTV formatted file is mapped to a text node. Conversely, each MPEG formatted file is mapped to a MPEG node. For each file directory on application streamer 109, a new node tree is created on broadcast streamer 114. Conversely, for each file on application streamer 109, a new node is created on broadcast streamer 114. The broadcast streamer 114 may then multiplex the text nodes and graphics nodes with the regular satellite broadcast stream 118 to create interactive stream 120.

Referring again to FIG. 3, the file directory structure on the application streamer 109 may comprise separate file folders for type of data and priority of data. For example, textual data may exist in a separate file folder from graphics (image) data. Further discussion of the file directory structure can be found below with regard to the description of FIG. 4. Within each file folder, a priority scheme may be created. Priority of each file may determine the amount of bandwidth allocated to each file within each file folder.

Turning again to FIG. 3, the process then proceeds to step 312, where the application streamer may perform bandwidth calculations. The application streamer 109 may assign bandwidth to each node based on the priority of the node. Priority of the node may be determined by various criteria, including size of node, popularity of movie, release date of movie, and other criteria. Since image files (that are mapped to graphics nodes) typically are larger in size than text files, image files will typically receive more bandwidth than text files. For example, image files are typically allocated 100 kilobits per second (Kbs) of bandwidth. Conversely, resource modules (that are mapped to text files) may receive 50 Kbs of bandwidth. Likewise, files labeled “priority 1” may receive more bandwidth than files labeled “priority 4”. For example, priority 1 files may be allocated 40 Kbs of bandwidth, “priority 2” files may receive 30 Kbs of bandwidth, “priority 3” files may receive 20 Kbs of bandwidth, and “priority 4” files may receive 10 Kbs of bandwidth. The application streamer 109 may assign bandwidth to the text and graphics nodes. Two types of data may receive bandwidth—image (graphics) data types and text data types. Each data type may comprise multiple levels of priorities. For example, each data type may comprise three levels of priorities: priority 1 (P1), priority 2 (P2), and priority 3 (P3). Both image data type and text data type may receive a maximum allowable combined bandwidth of 200 Kbs. Within the embodiment of FIG. 3, P1 data will be received by a set-top box three times faster than P3 data. As textual and graphical data accumulates on the FTP server 102, the bandwidth allocation for text and graphics nodes may change. For example, the amount of priority 1 (P1) image data on the FTP server 102 may increase from a size of 150 kilobits (Kb) to 200 Kb. As mentioned before, the maximum allowable bandwidth to be shared between image data and text data is fixed at a maximum of 200 Kbs. To accommodate the increased size of the image data, text bandwidth allocation may be reduced. Thus, if a time of 2.8 seconds was previously required to download an image file, 2.9 seconds may now be required to download an image file. The application streamer 109 may automatically change the ratio of image bandwidth to text bandwidth to accommodate an influx of data on the FTP server 102. Thus, each time the application streamer 109 creates new nodes, the application streamer 109 may re-calculate bandwidth allocation for each new node. The application streamer 109 therefore may assign new bandwidths to the data being streamed from the broadcast streamer 114. Formulas and numerical examples of bandwidth assignment for both image data and text data are given below.

### Calculating Bandwidth

P1=Priority 1, P2=Priority 2, P3=Priority 3

IMG=image

TEXT=text

BW=bandwidth

### EXAMPLE

IMG-P1=priority 1 contains 150 Kb of data,

IMG-P2=175 Kb,

IMG-P3=500 Kb.

TEXT-P1=50 Kb

TEXT-P2=70 Kb

TEXT-P3=90 Kb

To calculate the bandwidth of IMG-P1, and IMG-P2, and IMG-P3, the following formula is used:

S1=size of graphical information

S1=Size of IMG-P1*3 (in order to send priority 1 nodes three times faster than priority 3 nodes)+IMG-P2*2+IMG-P1*1

S1=150*3+175*2+500*1=450+350+500=1300 Kb

S2=size textual information

S2=Size of TEXT-P1*3 (in order to send priority 1 nodes three times faster than priority 3 nodes)+TEXT-P2*2+TEXT-P1*1

S2=50*3+70*2+90* 1=380

To find the total BW for IMG and TEXT:

IMG-BW=S1/(S1+S2)*TotalBW=1300/(1300+380)*200=154.8 Kb/second

TEXT-BW=S2/(S1+S2)*TotalBW=380/(1300+380)*200=45.2 Kbs/second

Divide the 154.8 Kb/s into 3 more bandwidths to accommodate the 3 levels of priority.

To find the BW of each priority in IMG

$$BW of IMG \text{-} P1 = Size of IMG \text{-} P1 \text{/} S1 * IMG \text{-} BW ( bandwidth of IMG ) \\ = 150 ( amount of date in P1 ) * 3 \text{/} 1300 * 154.8$$

$$( total BW for images ) \\ = 53.6 Kbs$$

BW of IMG-P2=175*2/1300*154.8=41.7 Kbs

BW of IMG-P3=500*1/1300*154.8=59.5 Kbs

As a verification:

$$\begin{matrix}BW of IMG \text{-} P1 + BW of IMG \text{-} P2 + \\ BW of IMG \text{-} P3\end{matrix} = 53.6 Kbs + 41.7 Kbs + 59.5 Kbs \\ = 154.8 Kbs$$

### Check

BW of IMG-P1 is 53.6 Kbs, therefore it will take 150 Kb/53.6 Kbs=2.8 seconds to transmit all of P1 data.

BW of IMG-P2 is 41.7 Kbs, therefore it will take 175 Kb/41.7 Kbs=4.2 seconds

BW of IMG-P3 is 59.5 Kbs, therefore it will take 500 Kb/59.5 Kbs=8.4 seconds.

Note: P3=3×P1, and P3=2×P2.

To find the BW of each priority in TEXT

BW of TEXT-P1=Size of TEXT-P1/S2*TEXT-BW (bandwidth TEXT)

BW of TEXT-P1=50 Kb*3/380 Kb*45.2 Kbs=17.8 Kbs

BW of TEXT-P2=70 Kb*2/380 Kb*45.2 Kbs=16.7 Kbs

BW of TEXT-P3=90 Kb*1/380 Kb*45.2 Kbs=10.7 Kbs

### Check

BW of TEXT-P1 is 17.8 Kbs, therefore it will take 50 Kb/17.8 Kbs=2.8 seconds to transmit all of P1 data.

BW of TEXT-P2 is 16.7 Kbs, therefore it will take 70 Kb/16.7 Kbs=4.2 seconds

BW of TEXT-P3 is 10.7 Kbs, therefore it will take 90 Kb/10.7 Kbs=8.4 seconds.

Note: P3=3xP1 and P3=2xP2.

| | | |
|---|---|---|
| Inputs: | | |
| Total Bandwidth | =TBW | =200 Kbs |
| Size of IMG priority P1 | =IMG_P1 | =150 Kb |
| Size of IMG priority P2 | =IMG_P2 | =175 Kb |
| Size of IMG priority P3 | =IMG_P3 | =500 Kb |
| Size of Text priority P1 | =TEXT_P1 | =50 Kb |
| Size of Text priority P2 | =TEXT_P2 | =70 Kb |
| Size of Text priority P3 | =TEXT_P3 | =90 Kb |

Outputs:

| | | |
|---|---|---|
| Bandwidth for IMG P1 | =IMG_P1_BW | =53.6 Kbs |
| Bandwidth for IMG P2 | =IMG_P2_BW | =41.7 Kbs |
| Bandwidth for IMG P3 | =IMG_P3_BW | =59.5 Kbs |
| Bandwidth for Text P1 | =TEXT_P1_BW | =17.8 Kbs |
| Bandwidth for Text P2 | =TEXT_P2_BW | =16.7 Kbs |
| Bandwidth for Text P3 | =TEXT_P3_BW | =10.7 Kbs |

| | | |
|---|---|---|
| Formulas: | | |
| Weighted sum of IMG | =IMG_S | =(IMG_P1*3 + IMG_P2*2 + IMG_P1*1) |
| Weighted sum of TEXT | =TEXT_S | =(TEXT_P1*3 + TEXT_P2*2 + |
| TEXT_P1*1) | | |
| Bandwidth of all of IMG | =IMG_BW | =(IMG_S/(IMG_S/TEXTS))* TBW |
| Bandwidth of all of TEXT | =TEXT_BW | =(TEXTS/(IMG_S/TEXTS)) * TBW |

| | |
|---|---|
| IMG_P1_BW | = (IMG_P1 * 3/(IMG_S)) * IMG_BW |
| IMG_P2_BW | = (IMG_P2 * 2/(IMG_S)) * IMG_BW |
| IMG_P3_BW | = (IMG_P3 * 1/(IMG_S)) * IMG_BW |
| TEXT_P1_BW | = (TEXT_P1 * 3/(TEXT_S)) * TEXT_BW |
| TEXT_P2_BW | = (TEXT_P2 * 2/(TEXT_S)) * TEXT_BW |
| TEXT_P3_BW | = (TEXT_P3 * 1/(TEXT_S)) * TEXT_BW |

Verifying formulas:

Sum of IMG_xx_BW=IMG_BW

Sum of TEXT_xx_BW=TEXT_BW

IMG_BW+TEXT_BW=TBW

IMG_P1_BW/IMG_P1*3=IMG_P2_BW/IMG_P2*2=IMG_P3_BW/IMG_P3*1

TEXT_P1_BW/TEXT_P1*332 TEXT_P2_BW/TEXT_P2*2=TEXT_P3_BW/TEXT_P3*1

IMG_P1/IMG_P1_BW=TEXT_P1/TEXT_P1_BW

IMG_P2/IMG_P2_BW=TEXT_P2/TEXT_P2_BW

IMG_P3/IMG_P3_BW=TEXT_P3/TEXT_P3_BW

Referring again to FIG. 3, the application streamer 109 may monitor the nodes to ensure the nodes are streaming properly. The application streamer 109 may also monitor function of the multiplexer that multiplexes the nodes into the regular satellite broadcast stream 118. The application streamer 109 may also monitor the connection to the broadcast streamer 114 as well as the connection to the FTP server 102. The application streamer 109 may periodically query the FTP server 102 to determine if any new data has been added to FTP server 102.

FIG. 4 is an illustration of a file directory structure created by the application streamer 109. Referring to FIG. 4, a file directory structure 400 may be located on the application streamer hard drive. The application streamer 109 may parse XML data, convert the XML data into OpenTV data, and create a file directory structure 400 as shown in FIG. 4. The application streamer may also convert JPEG and BMP data into MPEG data and create file directory structure 400. Referring to FIG. 4, MPEG files may be created in an image file folder 402. Image file folder 402 may comprise four files. Each file within image file folder 402 may comprise a MPEG “still”. MPEG-stills may comprise movie posters, still pictures from the movie, actor pictures, etc. Of course, image files may comprise graphical data of any format that may be read by OpenTV application 131. Each MPEG file may be assigned priority based on information gathered by the application streamer 109 while parsing the XML data. Priority is illustrated by file folders P1, P2, P3, and P4 within file folder image 402. P1 indicates files with the highest priority, and P4 indicates files with the lowest priority.

Referring again to FIG. 4, the OpenTV data may be stored in a resources file folder 404. Resources file folder 404 may comprise five files labeled P1 through P5. Again, P1 indicates files having the highest priority, whereas P5 indicates files of the lowest priority. Files P1 through P5 may comprise text files. As stated before, text files may contain information about an actor, movie, etc. The textual data may comprise any format readable by the OpenTV software 131 on set-top box 130. Files P1 through P4 in image folder 402 and files P1 through P5 in resources folder 404 may be prioritized according to file size, popularity of movie, year of movie creation, headlining actors, etc. The criteria for determining priority may be set by the content provider 100, and may be applied by application streamer 109. The application streamer 109 may extract information from the XML data such as year movie was created, size of file, and other information that may determine priority of the file. Files may be assigned bandwidth based on priority. The files with the highest priority may be assigned the most bandwidth and may therefore be transmitted to the user most frequently and rapidly than files with a lower priority. For example, a large MPEG file located within image folder 402 may be assigned more bandwidth than a file of smaller size. Conversely, images of newer movies may be assigned more bandwidth than images of older movies. In a hierarchy structure, the date of the movie may take precedence over the file size in determining bandwidth. Thus, even though file sizes for movies such as “Ghostbusters” (1979) may exceed file sizes for movies such as “Lord of the Rings” (2002), “Lord of the Rings” may be assigned more bandwidth than “Ghostbusters” and thus be transmitted to the user more quickly than “Ghostbusters”. This may act as an effective marketing tool for a content provider to encourage users to purchase subscriptions of movies that are more popular and/or recent.

FIG. 5 is an illustration of a graphical user interface (GUI) 500 that is used to create nodes. As shown in FIG. 5, GUI 500 may display graphics nodes 501. Text nodes are not shown in this illustration. Referring to FIG. 5, names of graphics nodes 501 may appear in text box 502. GUI 500 may be located on computers 134. GUI 500 may comprise status buttons that monitor the embodiment of FIG. 1. Turning to FIG. 5, the “broadcast streamer” status button 504 may indicate status (functionality) of the broadcast streamer 114. The “nodes” status button 506 may indicate status of nodes (whether or not the nodes are streaming properly). If the nodes are streaming successfully, a green light may illuminate the nodes status button 506. If nodes are dysfunctional and/or are not streaming properly, a red light may illuminate the nodes status button 506, and an error message may appear in log window 508. Log window 508 may indicate status of node creation system by displaying error messages. Looking again to FIG. 5, the “XML files” status button 510 may indicate the status of the FTP connection and the status of the XML files. The “raw files” status button 512 may indicate the status of successful transfer from XML file to a raw file. Raw files may comprise the extracted data from the XML files. The raw files may then be converted to compiled files. “compiled files” status button 514 may indicate whether the step of converting raw files to complied files has been completed successfully. Compiled files may comprise MPEG-stills and OpenTV resource modules. Compiled files may then be converted into spool files. Spool files may comprise a file structure used to create nodes. Referring again to FIG. 5, the “spool files” status button 516 may indicate whether the nodes have been created successfully. Simple network management protocol (SNMP) traps may be used to monitor the system/network. SNMP is a protocol used to manage networks. Within SNMP protocol, messages may be sent to the network, and agents (SNMP-compliant devices) may return data about the agents to the SNMP sender. In short, SNMP traps report that a device is functioning properly.

Turning again to FIG. 5, GUI 500 may also comprise buttons along the right hand side of GUI 500. The “create base nodes” button 518 may be activated after the spool files have been created. “Create base nodes” button 518 may be manually activated. The embodiment of FIG. 5 may use automated methods to create nodes. However, the embodiment of FIG. 5 also provides for manual creation of nodes. Referring again to FIG. 5, the “set node parameter” status button 520 may allow an author (person monitoring computers 134) to set node parameters such as date of node creation, maximum size of node, name of node, or other node parameters. The “load node data” button 522 may then be activated to indicate the particular broadcast stream in which the nodes are to be inserted. Multiple broadcast streamers 114 may exist within an uplink facility 104. There may also be multiple application streamers 109 within an uplink facility 104. Conversely, one application streamer 109 may be linked to multiple broadcast streamers 114. Furthermore, each broadcast streamer 114 may receive multiple regular broadcast streams 118. Therefore each node must be designated to a particular broadcast stream 118. Looking again to FIG. 5, the “refresh” button 524 may simply refresh the computer 134 screen. The “stop all” button 526 may be activated by the author if a warning message appears in log window 508 or a red light illuminates one of the status buttons at the top of the GUI 500. The “stop all” button 526 may stop all node insertion into the broadcast stream 118. The “play all” button 528 may be activated by the author to resume node insertion into the broadcast stream 118.

Looking again to FIG. 5, GUI 500 may comprise tabs located at the top GUI 500. Such tabs may comprise an “about” tab 530 that gives information about the application streamer 109. “broadcast streamer” tab 532 may comprise user name and password requirements as well as unique broadcast streamer addresses to create a connection to a particular broadcast streamer 114. The “application streamer” tab 534 may comprise information about application streamer 109. Referring again to FIG. 5, the “nodes” tab 536 is currently activated to display graphics nodes 501. The “data loader” tab 538 may contain a field that indicates the frequency at which the application streamer 109 queries the FTP 102 server for new data.

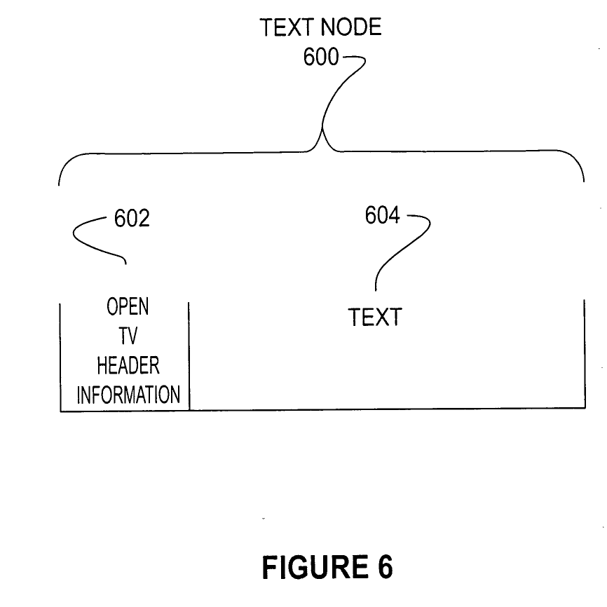

FIG. 6 is a graphical representation of a text node. As shown in FIG. 6, text node 600 may comprise a “block” of data. The text node 600 may comprise an OpenTV resource module. The text node 600 may comprise OpenTV header information 602 and text 604. Text 604 may comprise actor biographies, movie critiques, and other textual information. Of course, the OpenTV resource module may be created from any text format, including XML format.

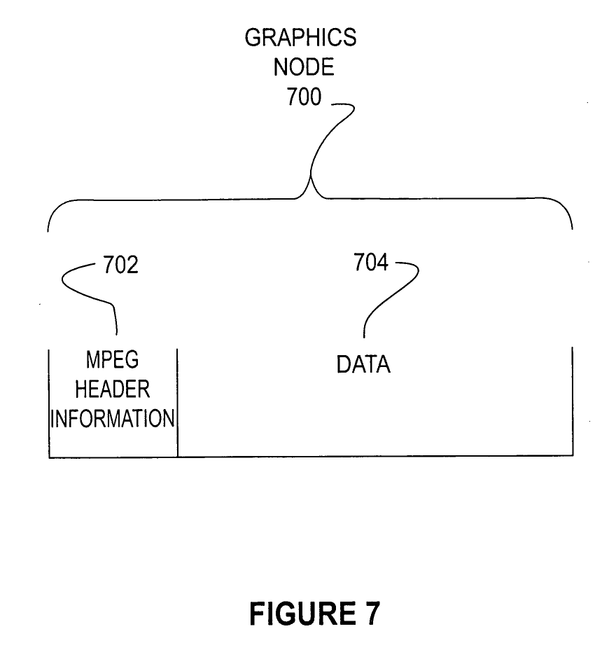

FIG. 7 is a graphical representation of a graphics node. As shown in FIG. 7, the graphics node 700 may comprise a “block” of data. The graphics node 700 may comprise MPEG header information 702 and graphical data 704. Graphical data 704 may comprise an MPEG-still. As before, the MPEG-still may comprise movie posters, actor pictures, still pictures from a movie, or other graphical information. Again, the graphics node may be created from any graphics format, including JPEG and BMP formats.

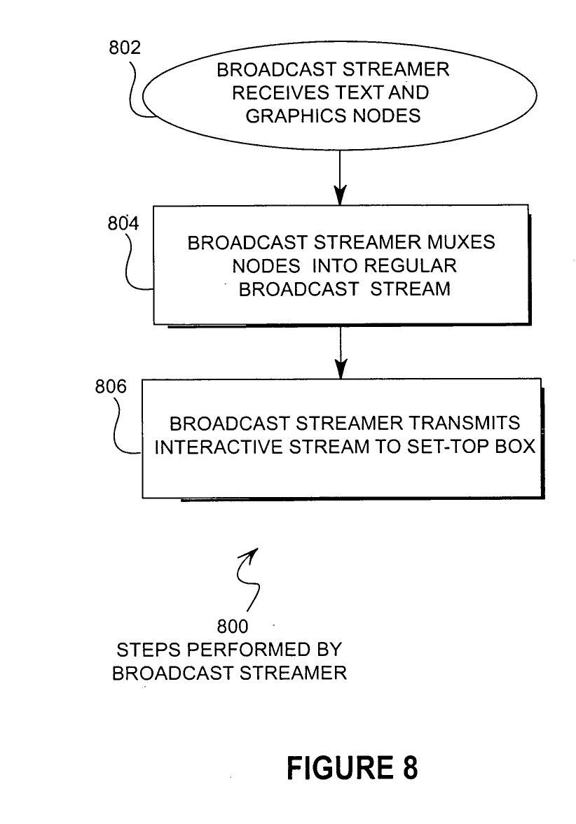

FIG. 8 is a flow diagram illustrating the steps 800 performed by a broadcast streamer in carrying out the embodiment of FIG. 1. Referring to FIG. 8, broadcast streamer 114 may receive OpenTV data and graphics data (which may be in the form of MPEG data) from application streamer 109 in step 802. The process proceeds to step 804 where the broadcast streamer 114 ingests OpenTV nodes and MPEG nodes into the current existing satellite broadcast stream 118. The broadcast streamer 114 may add the OpenTV and MPEG data to the audio/video of all the other channels being transmitted from the uplink facility 104, resulting in an interactive stream 120. Adding the OpenTV data and MPEG data to the regular broadcast stream may be achieved by multiplexing the OpenTV and MPEG data with the regular broadcast stream. As described previously with regard to the description of FIG. 1, a multiplexer may comprise standard, off-the-shelf technology such as OpenTV Broadcast Streamer v2.1 or other multiplexers. Turning again to FIG. 8, the process then proceeds to step 806 where the broadcast streamer 114 may transmit the interactive stream 120 to a system of satellite hardware 122. The satellite hardware 122 may then transmit the interactive stream 120 to a satellite 126, which may in turn transmit the interactive stream 120 to a user's set-top box 130.

The present invention therefore provides a system and method that allows additional, interactive movie information to be displayed to a user on a display device. The present invention provides visual information on movies and other programming data, including still shots from the movie, movie posters, actor pictures, actor and movie biographies and additional information, etc.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for sending interactive textual and graphical data from a content provider to a user's set-top box through a satellite broadcast system comprising:
sending said textual data and said graphical data from said content provider to a server that is located in an uplink center;
converting said textual data into OpenTV data and converting said graphical data into MPEG data by using an application streamer that is coupled to said server and that retrieves said textual data and said graphical data from said server;
using said application streamer to create a file directory structure based on said textual data;
using said application streamer to create a node tree on a broadcast streamer by mirroring said file directory structure;
mapping nodes in said node tree to files in said file directory structure;
allocating bandwidth and transmission frequency of said node based on priority of said node;
using said broadcast streamer to multiplex said OpenTV data and said MPEG data with a regular broadcast stream resulting in an interactive data stream; and,
sending said interactive data stream to said user's set-top box.

2. The method of claim 1 further comprising:
using set-top box application software to read said interactive data stream and display said interactive data stream on a user's display device; and,
monitoring said application streamer with a computer.

3. The method of claim 1 wherein said step of retrieving said textual data and said graphical data from said server further comprises querying said server for new data.

4. The method of claim 1 wherein said step of converting said textual data into said OpenTV data and converting said graphical data into said MPEG data further comprises creating system alerts.

5. The method of claim 4 wherein said step of creating system alerts comprises creating alerts upon detection of errors within said satellite broadcast system using SNMP traps, event logging, and visual queues in a graphical user interface.

6. The method of claim 2 wherein said step of monitoring said application streamer by a computer further comprises monitoring said application streamer, configuring said application streamer, making any necessary changes to said application streamer.

7. The method of claim 6 wherein said step of monitoring said application streamer further comprises monitoring said application streamer using a DCOM user interface over a network connection.

8. The method of claim 7 wherein said step of monitoring said application streamer further comprises monitoring the connection to said broadcast streamer, monitoring the connection to said server, and monitoring the status of said interactive data stream on said broadcast server.

9. A system for sending interactive textual and graphical data from a content provider to a user's set-top box through a satellite broadcast system comprising:
a server, located in an uplink center, that receives said textual data and said graphical data from said content provider;
an application streamer, that is coupled to said server, that retrieves said textual data and said graphical data from said server, and that converts said textual data into OpenTV data and converts said graphical data into MPEG data;
a file directory structure that is created by said application streamer based on said textual data;
a node tree that is created by said application streamer on a broadcast streamer by mirroring said file directory structure;
nodes in said node tree that are mapped to files in said file directory structure;
bandwidth allocation software, in said application streamer, that calculates transmission frequency of said node based on priority of said node; and,
a multiplexer located on said broadcast streamer that multiplexes said OpenTV data and said MPEG data with a regular broadcast stream resulting in an interactive data stream.

10. The system of claim 9 further comprising:
a set-top box that receives said interactive data stream;
a software application located on said set-top box that reads said interactive data stream and displays said interactive data stream on a user's display device; and
a computer that monitors said application streamer.
